(19) United States
(12) Patent Application Publication
(10) Pub. No.: US 2018/0145525 A1
(43) Pub. Date: May 24, 2018

(54) CHARGING MANAGMENT METHOD AND SYSTEM THEREOF

(71) Applicant: O2Micro Inc., Santa Clara, CA (US)

(72) Inventors: Sterling DU, Shanghai (CN); Mingfeng WANG, Shanghai (CN); Xinsheng PENG, Wuhan (CN)

(21) Appl. No.: 15/807,402

(22) Filed: Nov. 8, 2017

(30) Foreign Application Priority Data
Nov. 23, 2016 (CN) 201611041243.5

(51) Int. Cl. H02J 7/00

(52) U.S. Cl. CPC H02J 7/0055; H02J 2007/005; H02J 7/0073

(57) ABSTRACT

A charging management method includes: identifying a type of adapter that is connected to a device including a battery, wherein the type of adapter is one of at least a first type adapter and a second type adapter; if the first type adapter is connected, setting a bypass/LDO (low dropout regulator) module to a first control mode including one of a bypass mode and a hybrid control mode; and if the second type adapter is connected, setting the bypass/LDO module to a second control mode including the hybrid control mode, wherein the bypass/LDO module includes a first transistor and a second transistor.

### RELATED APPLICATION

This present application claims priority to Chinese Patent Application No. 201611041243.5, titled “Charging Management Method of Portable Device and System Thereof,” filed on Nov. 23, 2016, with the State Intellectual Property Office of the People's Republic of China, hereby by incorporated by reference in its entirety.

### BACKGROUND

Nowadays, devices such as smart phones, tablet computers, palm computers, etc., are more and more popular. However, these devices consume more electricity with more charging cycles. Furthermore, adapter types are becoming more varied. For example, there are regular adapters, adapters supporting a 5V/10V quick charging scheme, and O2Micro Cool Charge® adapters supporting a 3.5V˜5V express charging scheme. For example, users may sometimes use a regular adapter and other times use the Cool Charge® adapter. If the device uses the same charging management scheme without considering the adapter type, then charging efficiency may be decreased or there may be unexpected damage to the device.

### SUMMARY

To solve the above problem, embodiments according to the present invention provide a charging management method, including: identifying a type of adapter that is connected to a device including a battery, wherein the type of adapter is one of at least a first type adapter and a second type adapter; if the first type adapter is connected, setting a bypass/LDO (low dropout regulator) module to a first control mode including one of a bypass mode and a hybrid control mode; and if the second type adapter is connected, setting the bypass/LDO module to a second control mode including the hybrid control mode, wherein the bypass/LDO module includes a first transistor and a second transistor; wherein for the first control mode, a first enable signal and a second enable signal respectively control the first transistor and the second transistor so that, during a larger current charging stage of the battery, the first transistor and the second transistor both function as switches and a bypass path is formed, and so that, during a smaller current charging stage of the battery, the first transistor functions as a switch and the second transistor functions as an LDO and a hybrid path is formed, and wherein for the second control mode, the first enable signal and the second enable signal respectively control the first transistor and the second transistor so that the first transistor functions as a switch and the second transistor functions as an LDO and the hybrid path is formed.

Embodiments according to the present invention also provide a device, including: a bypass/LDO (low dropout regulator) module including a first transistor and a second transistor; and a device control module configured to identify a type of an adapter that is connected to the device, wherein the type of adapter is one of at least a first type adapter and a second type adapter, and is also configured to transmit a first control signal to the bypass/LDO module according to the type of adapter, wherein the bypass/LDO module is configured to set a control mode according to the first control signal, wherein the control mode is one of a first control mode and a second control mode; wherein if the first type adapter is connected to the device, then the bypass/LDO module is set to the first control mode including one of a bypass control mode and a hybrid control mode; and wherein if the second type adapter is connected to the device, then the bypass/LDO module is set to the second control mode including the hybrid control mode; wherein for the first control mode, the first control signal controls the first transistor and the second transistor so that, during a larger current charging stage of a battery of the device, the first transistor and the second transistor both function as switches and a bypass path is formed and so that, during a smaller current charging stage of the battery, the first transistor functions as a switch and the second transistor functions as an LDO and a hybrid path is formed; and wherein for the second control mode, the first control signal controls the first transistor and the second transistor so that the first transistor functions as a switch and the second transistor functions as an LDO and the hybrid path is formed.

Advantageously, charging management methods according to the present invention can identify the adapter type and perform corresponding controls, to increase charging efficiency and ensure charging safety. Furthermore, by utilizing selective bypass or hybrid control, a bypass path can be formed during the larger current charging stage of the battery to improve efficiency, thus reducing power consumption and heat.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a block diagram of a charging management system according to an embodiment of the present invention;

FIG. 2 shows a block diagram of a charging management system according to another embodiment of the present invention;

FIG. 3 shows a block diagram of a charging management system according to another embodiment of the present invention;

FIG. 4 shows a block diagram of a charging management system according to another embodiment of the present invention; and

FIG. 5 shows a flowchart of a charging management method according to an embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

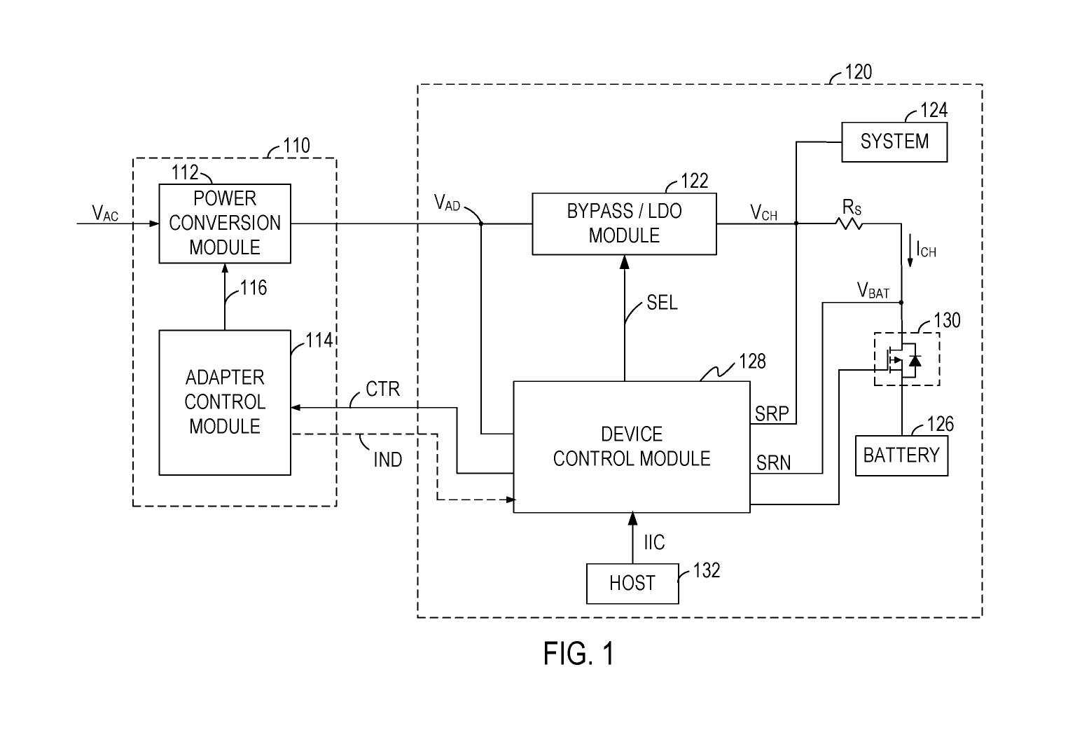

FIG. 1 shows a block diagram of a charging management system according to an embodiment of the present invention. As shown in FIG. 1, the charging management system is implemented on a device 120 that can be connected to an adapter 110. In an embodiment, the device 120 is a portable device such as a smart phone, a tablet computer, a palm computer, etc. In another embodiment, by way of example and not limitation, the device 120 can be a device such as a camera, an electric toothbrush, an electric shaver, a wireless headphone, etc. The device 120 can be powered by the adapter 110 and a battery 126. The device 120 can also cooperate with the adapter 110 to charge the battery 126. The battery 126 can be, by way of example and not limitation, a single-cell or multi-cell lithium-ion polymer battery, lead-acid battery, nickel-cadmium battery, a nickel-metal hydride battery, etc. In an embodiment, the battery has at least two charging stages, referred to herein as the larger current charging stage and the smaller current charging stage. For example, at the beginning of the charging process, the battery enters the larger current charging stage, and the charging current of the battery may be about 2-4 ampere (A). At the end of the charging process, the battery enters the smaller current charging stage, and the charging current of the battery may be about 0-1.5 ampere (A).

In an embodiment, the adapter 110 includes a power conversion module 112 and an adapter control module 114. The power conversion module 112 can receive an alternating current (AC) voltage V_{AC}, e.g., 220 VAC or 110 VAC, from a power supply and convert an AC input voltage to a direct current (DC) output voltage V_{AD}. The adapter control module 114 can include one or more control ports coupled to the power conversion module 112, and can generate one or more control signals 116 on the one or more control ports, to regulate an output power or an output voltage of the adapter 110 to a target value. In an embodiment, the adapter control module 114 includes a processing unit (not shown) for performing machine-readable instructions.

The adapter 110 can be either a first type adapter (e.g., an O2Micro Cool Charge® adapter supporting a 3.5V-5V express charging scheme) or a second type adapter (e.g., a regular adapter supporting a 5V/10V quick charging scheme). As will be seen from the discussion to follow, embodiments according to the present invention can identify a type of adapter and manage battery charging accordingly. While that discussion presents examples based on identifying a type of adapter from two types of adapters, the present invention is not so limited. That is, embodiments according to the present invention can be used to identify a type of adapter from more than two types of adapters.

In an embodiment, the output voltage default value (e.g., 3.5V) of the first type adapter is lower than the output voltage default value (e.g., 5V) of the second type adapter. In an embodiment, the output voltage of the first type adapter changes as the control signal 116 changes. For example, when the voltage, current, or duty cycle of the control signal 116 changes, the output voltage of the first type adapter can increase from 3.5V to 4V or 5V or some other value, or it can decrease from 5V to 3.5V or some other value. The output voltage of the second type adapter remains unchanged as the control signal 116 changes. For example, when the voltage, current, or duty cycle of the control signal 116 changes, the output voltage of the second type adapter stays at 5V.

In an embodiment, the device 120 includes a bypass/LDO (Low Dropout Regulator) module 122, system circuitry 124, a battery 126, a device control module 128, and a transistor 130. The system circuitry 124 includes other circuitry, components, or devices that consume the electric energy of the battery 126, such as the CPU or camera of the device 120, for example. The device control module 128 is coupled to the adapter 110, and is configured to identify whether a first type adapter (e.g., an O2Micro Cool Charge® adapter) or a second type adapter (e.g., a regular adapter) is connected to the device 120, and is also configured to transmit a control signal CTR (which may be referred to herein as the second control signal) to the adapter control module 114 of the adapter 110.

In an embodiment, the device control module 128 identifies the type of adapter 110 by detecting an output voltage default value of the adapter before charging. For example, if the detected output voltage default value of the adapter equals 3.5V, then the currently connected adapter is identified as the first type adapter (e.g., an O2Micro Cool Charge® adapter). If the detected output voltage default value of the adapter equals 5V, then the currently connected adapter is identified as the second type adapter (e.g., the regular adapter).

In an embodiment, the device control module 128 identifies the type of adapter by changing the control signal CTR (e.g., the voltage, current, or duty cycle of the control signal CTR) and monitoring whether the output voltage V_{AD} of the adapter 110 changes. For example, if the detected output voltage V_{AD} of the adapter 110 changes as the control signal 116 changes, e.g., the detected output voltage increases from 3.5V to 4V or 5V or another value, then the currently connected adapter is identified as the first type adapter (e.g., an O2Micro Cool Charge® adapter). If the detected output voltage V_{AD} of the adapter 110 remains unchanged as the control signal 116 changes, e.g., it stays at 5V, then the currently connected adapter is identified as the second type adapter (e.g., a regular adapter).

In an embodiment, if the currently connected adapter 110 is the first type adapter (e.g., an O2Micro Cool Charge® adapter), then the adapter control module 114 of the adapter 110 can send a control signal with an adapter type indicator IND (shown as a dotted line with an arrowhead) to the device control module 128. If the device control module 128 receives the adapter type indicator from the adapter control module 114, then the currently connected adapter is identified as the first type adapter (e.g., an O2Micro Cool Charge® adapter). If the device control module 128 does not receive the adapter type indicator from the adapter control module 114, then the currently connected adapter is identified as the second type adapter (e.g., a regular adapter).

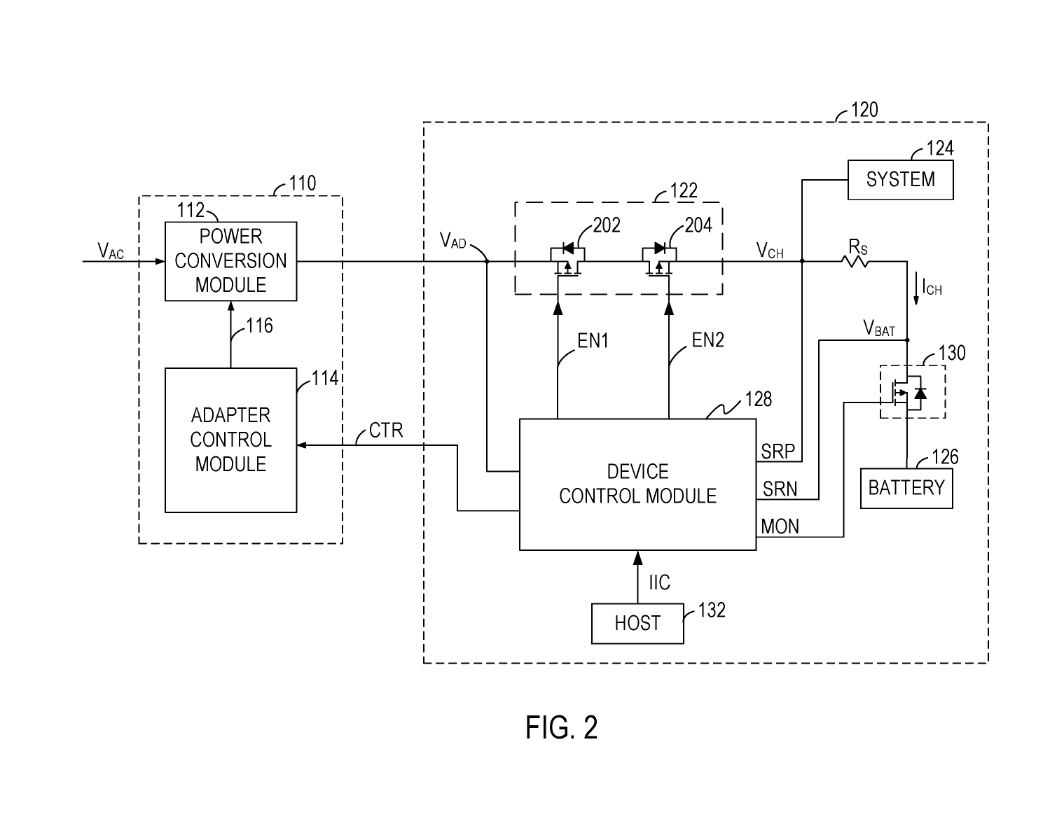

After identifying whether the first type adapter (e.g., an O2Micro Cool Charge® adapter) or the second type adapter (e.g., a regular adapter) is connected to the device 120, the device control module 128 transmits a control signal SEL (which may be referred to herein as the first control signal) to the bypass/LDO module 122, according to the identified adapter type. In an embodiment, the control signal SEL includes a group of signals, e.g., an enable signal EN1 and an enable signal EN2 as shown in the example of FIG. 2. The bypass/LDO module 122 is set to a first control mode or a second control mode according to the control signal SEL. Specifically, if the first type adapter (e.g., an O2Micro Cool Charge® adapter) is connected to the device 120, then the bypass/LDO module 122 is set to the first control mode, which is either a bypass mode or a hybrid control mode; in the first control mode, the bypass mode or the hybrid control mode is selected as described below. If the second type adapter (e.g., the regular adapter) is connected to the device 120, then the bypass/LDO module 122 is set to the second control mode, which is the hybrid control mode.

Further explanation is given below in combination with a charging management system of FIG. 2. The bypass/LDO module 122 can include a first transistor 202 and a second transistor 204 (e.g., MOSFET transistors). The device control module 128 can transmit the enable signals EN1 and EN2 to the first transistor 202 and the second transistor 204 respectively, to enable the first transistor 202 and the second transistor 204 to function as a switch (bypass) or an LDO. In an embodiment, the bypass/LDO module 122 is further used as a charge pump and to perform boost operations.

TABLE 1
Example of Transistor Function in Different Charging Stages

| | First Type Adapter | | Second Type Adapter | |
|---|---|---|---|---|
| | (e.g., COOL CHARGE ®) | | (e.g., Regular Adapter) | |
| | Large | Small | Large | Small |
| | Current | Current | Current | Current |
| | Charging | Charging | Charging | Charging |
| | Stage | Stage | Stage | Stage |
| Transistor 202 | Switch | Switch | Switch | Switch |
| Transistor 204 | Switch | LDO | LDO | LDO |
| Bypass/LDO | Bypass Path | Hybrid Path | Hybrid Path | Hybrid Path |
| Module 122 | | | | |

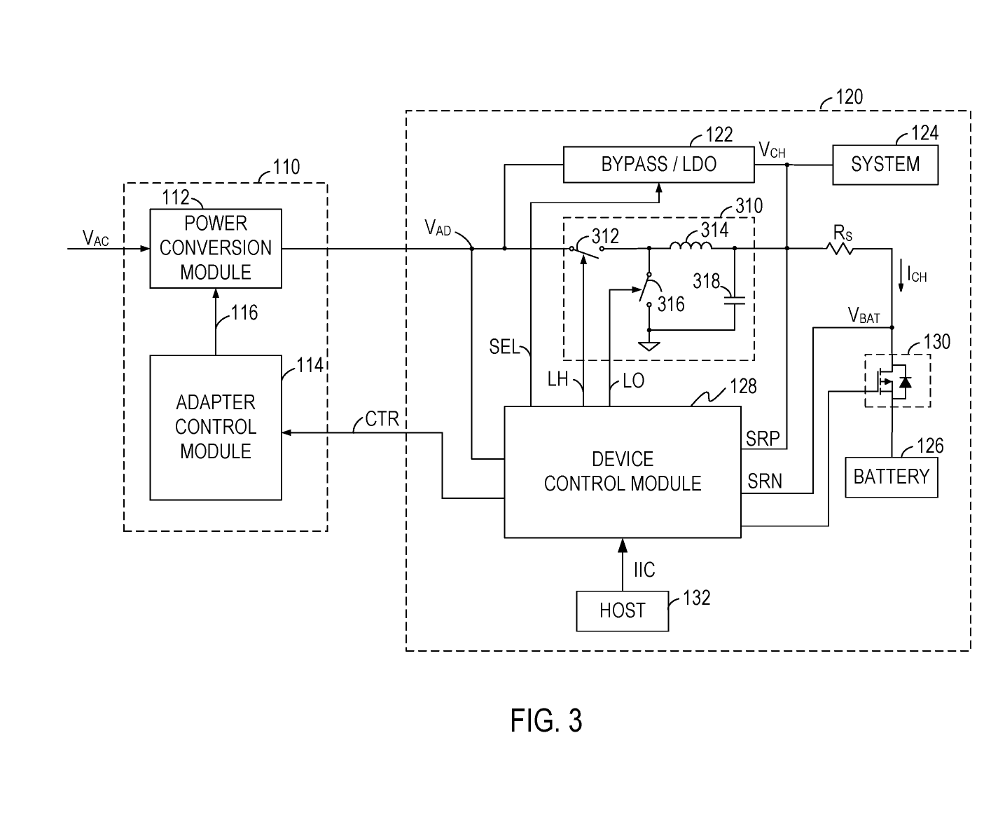

NOTE:
According to a priority setting, a switch charging module 310 (FIG. 3) can replace the hybrid path in the bypass/LDO module 122.

With reference to Table 1, if the first type adapter (e.g., an O2Micro Cool Charge® adapter) is connected, then the bypass/LDO module 122 is set to the first control mode, which is either a bypass mode or a hybrid control mode.

In the bypass mode of the first control mode, which is during the larger current charging stage of the battery 126, the first transistor 202 and the second transistor 204 both function as switches, so that a bypass path is formed. The bypass path may cause a very slight voltage drop, which can be considered to be negligible. The bypass/LDO module 122 bypasses the adapter output voltage V_{AD} and outputs the voltage V_{CH} without power conversion (boost or buck operation).

In the hybrid control mode of the first control mode, which is during the smaller current charging stage of the battery 126, the first transistor 202 functions as a switch and the second transistor 204 functions as an LDO, so that a switch/LDO hybrid path (hereafter referred to as the “hybrid path”) is formed. The bypass/LDO module 122 converts the adapter output voltage V_{AD} into the lower voltage V_{CH}.

If the second type adapter (e.g., a regular adapter) is connected, then the bypass/LDO module 122 is set to the second control mode, which is also the hybrid control mode, regardless of whether the battery 126 is in the larger current charging stage or the smaller current charging stage. The first transistor 202 functions as a switch and the second transistor 204 functions as an LDO, so that the hybrid path is formed. The bypass path has higher efficiency and less power consumption compared to the hybrid path.

The device control module 128 can detect the voltages SRP and SRN at two ends of a resistor R_{S} coupled to the battery 126 to obtain the charging current I_{CH} and the battery voltage V_{BAT}, to determine whether the battery 126 is in the larger current charging stage or the smaller current charging stage. In an embodiment, instead of utilizing a resistor, the device control module 128 monitors a current MON flowing through a transistor 130 coupled to the battery 126, and performs a trimming calculation on the monitored current MON to obtain the charging current I_{CH} and the battery voltage V_{BAT}. These two ways can be used separately or in combination.

In an embodiment, the device control module 128 cooperates with the adapter control module 114 for close loop control, in order to regulate the output power or output voltage of the adapter 110 to a target value. For example, the device control module 128 can obtain a feedback signal indicative of a charging parameter (e.g., the charging current I_{CH} or battery voltage V_{BAT}). For example, the device control module 128 can detect the voltages SRP and SRN at two ends of the resistor R_{S} coupled to the battery 126 to obtain the charging current I_{CH} and the battery voltage V_{BAT}. The device control module 128 can also send the corresponding control signal CTR to the adapter control module 114, according to the feedback signal. In an embodiment, if the charging current I_{CH} exceeds a preset charging current level, then the device control module 128 sends the control signal CTR to the adapter control module 114, to decrease the charging current I_{CH} to the preset level.

In an embodiment, the control signal CTR is a current signal, a voltage signal, a pulse-width modulation (PWM) signal, or a pulse-frequency modulation (PFM) signal The control signal CTR can be determined by the battery voltage V_{BAT}, the charging current I_{CH} of the battery 126, the system current, and the adapter output power. For example, the control signal CTR can be a PWM signal. If the charging current I_{CH} exceeds the preset charging current level, then the device control module 128 decreases the duty cycle of the control signal CTR sent to the adapter control module 114, to decrease the charging current I_{CH} and regulate the output power or output voltage of the adapter 110 to the target value. In another embodiment, the device control module 128 increases the duty cycle of the control signal CTR to decrease the charging current I_{CH} and regulate the output power or output voltage of the adapter 110 to the target value.

In an embodiment, the device control module 128 further includes an integrated circuitry bus (Inter-Integrated Circuit, IIC), configured to adjust the control signal CTR of the device control module 128 according to a host command from a host device 132 (e.g., a micro controller unit of the device 120). For example, the host device 132 can generate the host command in response to a user operation on the device 120, such as via the battery management application installed on the device 120. Furthermore, peripheral capacitors and resistors and the transistors 130, 202, and 204 can be integrated into the device control module 128, to reduce material costs and printed circuit board area.

FIG. 3 shows a block diagram of a charging management system according to another embodiment of the present invention. The charging management system in FIG. 3 is similar to the charging management system in FIG. 2 except for an extra switch charging module 310. As shown in FIG. 3, the switch charging module 310 can include switch circuitry that includes a high-side switch 312 and a low-side switch 316, an inductor 314, and filter circuitry (e.g., a capacitor 318). The high-side switch 312 and the low-side switch 316 are respectively controlled by the control signals LH and LO of the device control module 128. During the larger current charging stage, the switch charging module 310 has lower power conversion efficiency compared to the bypass path. Therefore, for the first type adapter (e.g., an O2Micro Cool Charge® adapter), during the larger current charging stage, the bypass path of the bypass/LDO module 122 is used for power delivery. During the smaller current charging stage, the switch charging module 310 has higher power conversion efficiency compared to the hybrid path. For example, the switch charging module 310 can be set to have a higher priority than the hybrid path of the bypass/LDO module 122 and a lower priority than the bypass path of the bypass/LDO module 122. Therefore, for the first type adapter, during the larger current charging stage, the bypass path of the bypass/LDO module 122 can replace the the switch charging module 310. During the smaller current charging stage, the switch charging module 310 can replace the hybrid path of the bypass/LDO module 122 according to the priority setting. During the larger current charging stage and the smaller current charging stage of the second type adapter, the switch charging module 310 can be used for power delivery, as noted in Table 1.

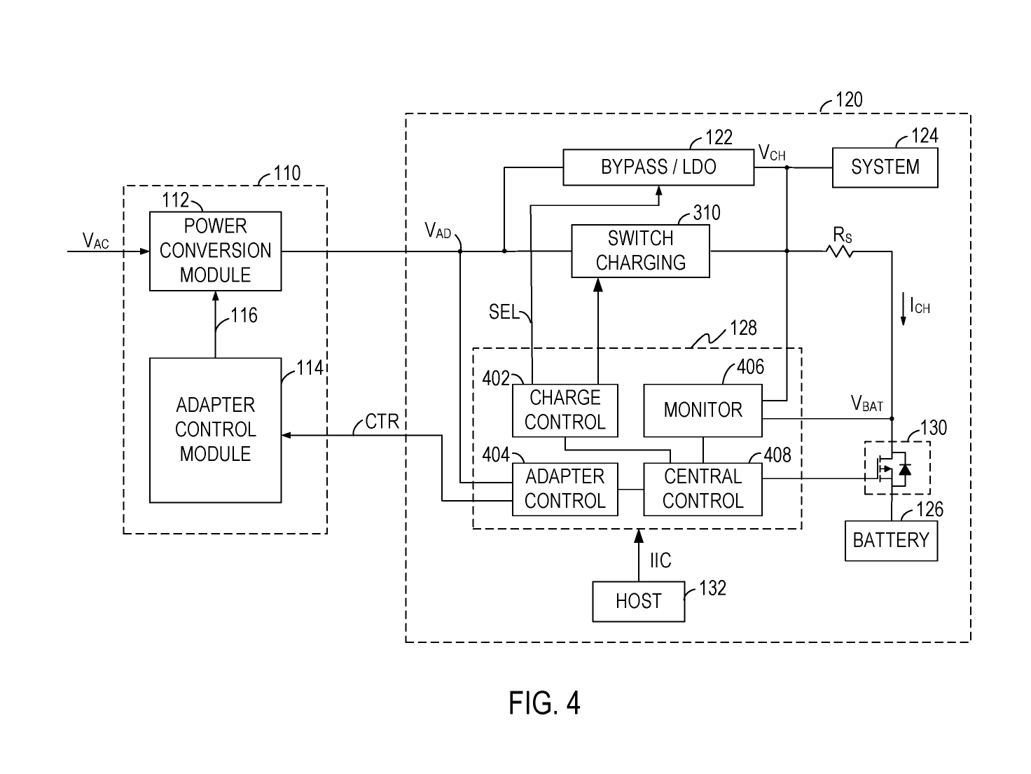

FIG. 4 shows a block diagram of a charging management system according to another embodiment of the present invention. The charging management system in FIG. 4 is similar to the charging management system in FIG. 3 except for the structure of the device control module 128. As shown in FIG. 4, the device control module 128 can include a charge control unit 402, an adapter control unit 404, a monitor unit 406, and a central control unit 408. The adapter control unit 404 can identify whether the first type adapter (e.g., an O2Micro Cool Charge® adapter) or the second type adapter (e.g., a regular adapter) is connected, and is configured to transmit the control signal CTR to the adapter control module 114 of the adapter 110 according to the adapter output V_{AD}. The central control unit 408 can receive a type indicator signal indicative of the adapter type from the adapter control unit 404 and also can receive a battery status signal indicative of the charging current and the battery voltage from the monitor unit 406, and can determine whether the battery 126 is currently in the larger current charging stage or the smaller current charging stage. Correspondingly, the charge control unit 402 coupled to the central control unit 408 can selectively enable the bypass/LDO module 122 and the switch charging module 310 according to the adapter type and the current charging level (higher or lower) through the control signals SEL (including EN1 and EN2), LH, and LO. The detailed enable and disable descriptions are described above in conjunction with FIG. 2 and FIG. 3.

Furthermore, the adapter control unit 404 can obtain a feedback signal indicative of the charging parameter (e.g., the charging current I_{CH} or the battery voltage V_{BAT}) from the monitor unit 406. According to the feedback signal, the adapter control unit 404 transmits the corresponding control signal CTR to the adapter control module 114. For example, the control signal CTR can be a PWM signal. If the charging current I_{CH} exceeds the preset charging current level, then the adapter control unit 404 of the device control module 128 decreases the duty cycle of the control signal CTR sent to the adapter control module 114, to decrease the charging current I_{CH} and regulate the output power or output voltage of the adapter 110 to the target value. In another embodiment, the device control module 128 increases the duty cycle of the control signal CTR to decrease the charging current I_{CH} and regulate the output power or output voltage of the adapter 110 to the target value.

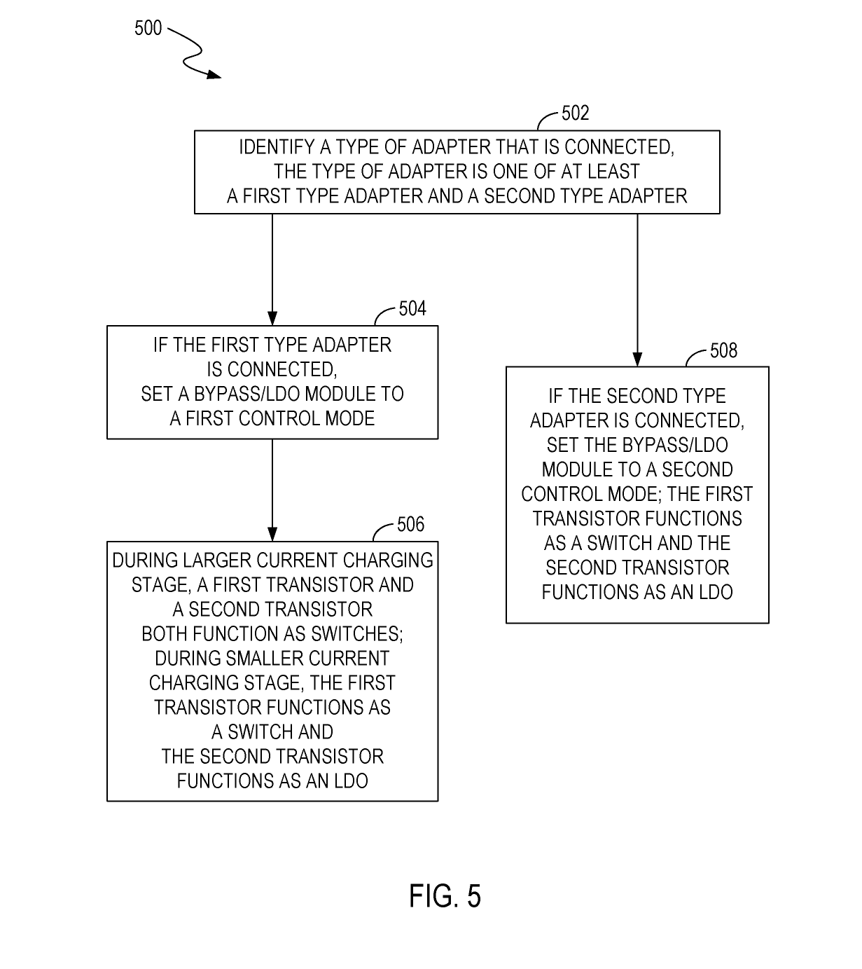

FIG. 5 shows a flowchart of a charging management method 500 of a device (the device 120) according to an embodiment of the present invention. FIG. 5 is described in combination with FIGS. 1-4.

In block 502, the first type adapter (e.g., an O2Micro Cool Charge® adapter) or the second type adapter (e.g., a regular adapter) is identified as being connected to the device 120. In an embodiment, the output voltage default value (e.g., 3.5V) of the first type adapter is lower than the output voltage default value (e.g., 5V) of the second type adapter. In an embodiment, the output voltage of the first type adapter changes as the control signal 116 changes. For example, when the voltage, current, or duty cycle of the control signal 116 changes, the output voltage of the first type adapter can increase from 3.5V to 4V or 5V or some other value. The output voltage of the second type adapter remains unchanged as the control signal 116 changes. For example, when the voltage, current, or duty cycle of the control signal 116 changes, the output voltage of the second type adapter stays at 5V.

In an embodiment, in block 502, the device control module 128 in the device 120 identifies the adapter type by detecting an output voltage default value of the adapter before charging. For example, if the detected output voltage default value of the adapter is 3.5V, then the currently connected adapter is identified as the first type adapter (e.g., an O2Micro Cool Charge® adapter). If the detected output voltage default value of the adapter is 5V, then the currently connected adapter is identified as the second type adapter (e.g., a regular adapter).

In an embodiment, in block 502, the device control module 128 in the device 120 identifies the adapter type by changing the control signal CTR (e.g., the voltage, current, or duty cycle of the control signal CTR) and monitoring whether the output voltage V_{AD} of the adapter 110 changes. For example, if the detected output voltage V_{AD} of the adapter 110 changes as the control signal 116 changes, e.g., it increases from 3.5V to 4V or 5V or some other value, then the currently connected adapter is identified as the first type adapter (e.g., an O2Micro Cool Charge® adapter). If the detected output voltage V_{AD} of the adapter 110 remains unchanged as the control signal 116 changes, e.g., it stays at 5V, then the currently connected adapter is identified as the second type adapter (e.g., a regular adapter).

In an embodiment, in block 502, the device control module 128 in the device 120 identifies the adapter type by detecting whether a control signal with an adapter type indicator is received from the adapter control module 114 in the adapter 110. If the currently connected adapter 110 is the first type adapter (e.g., an O2Micro Cool Charge® adapter), then the adapter control module 114 of the adapter 110 can send a control signal with an adapter type indicator (as shown in FIG. 1) to the device control module 128. If the device control module 128 receives the adapter type indicator from the adapter control module 114, then the currently connected adapter is identified as the first type adapter (e.g., an O2Micro Cool Charge® adapter). If the device control module 128 does not receive the adapter type indicator from the adapter control module 114, then the currently connected adapter is identified as the second type adapter (e.g., a regular adapter).

In block 504, if the first type adapter (e.g., an O2Micro Cool Charge® adapter) is connected to the device 120, then the bypass/LDO module 122 is set to the first control mode, which is either a bypass mode or a hybrid control mode.

In block 506, in the first control mode and during the larger current charging stage of the battery 126, the enable signals EN1 and EN2 control the first transistor 202 and the second transistor 204 respectively, so that the first transistor 202 and the second transistor 204 both function as switches. In this way, a bypass path is formed and the bypass mode is implemented. The bypass path may cause a very slight voltage drop, which can be considered negligible. The bypass/LDO module 122 bypasses the adapter output voltage V_{AD} and outputs the voltage V_{CH} without power conversion (boost or buck operation). In the first control mode and during the smaller current charging stage of the battery 126, the enable signals EN1 and EN2 control the first transistor 202 and the second transistor 204 respectively, so that the first transistor 202 functions as a switch and the second transistor 204 functions as an LDO. In such way, the switch/LDO hybrid path is formed and the hybrid control mode is implemented. The bypass/LDO module 122 converts the adapter output voltage V_{AD} into the lower voltage V_{CH}.

In block 508, if the second type adapter (e.g., a regular adapter) is connected to the device 120, then the bypass/LDO module 122 is set to the second control mode, which is the hybrid control mode. Regardless of whether the battery 126 is in the larger current charging stage or the smaller current charging stage, the enable signals EN1 and EN2 control the first transistor 202 and the second transistor 204 respectively, so that the first transistor 202 functions as a switch and the second transistor 204 functions as an LDO. In this way, the hybrid path is formed. The bypass path has higher efficiency and less power consumption compared to the hybrid path.

In an embodiment, the switch charging module 310 in the device 120 replaces the hybrid path of the bypass/LDO module 122 according to a priority setting. Specifically, during the larger current charging stage, the switch charging module 310 has lower power conversion efficiency compared to the bypass path. Therefore, for the first type adapter (e.g., an O2Micro Cool Charge® adapter), during the larger current charging stage, the bypass path of the bypass/LDO module 122 is used for power delivery. During the smaller current charging stage, the switch charging module 310 has higher power conversion efficiency compared to the hybrid path. Therefore, for the first type adapter, during the smaller current charging stage, the switch charging module 310 can replace the hybrid path of the bypass/LDO module 122 according to the priority setting. For the second type adapter, during the larger current charging stage and the smaller current charging stage, the switch charging module 310 can be used for power delivery, as shown in Table 1.

The charging process can further include close loop control, to regulate the output power or output voltage of the adapter 110 to a target value. For example, the device control module 128 can obtain a feedback signal indicative of a charging parameter (e.g., the charging current I_{CH} or battery voltage V_{BAT}). For example, the device control module 128 can detect the voltages SRP and SRN at two ends of a resistor R_{S} coupled to the battery 126 to obtain the charging current I_{CH} and the battery voltage V_{BAT}. The device control module 128 can also send the corresponding control signal CTR to the adapter control module 114, according to the feedback signal. In an embodiment, if the charging current I_{CH} or the battery voltage V_{BAT} exceeds a preset charging current level or preset battery voltage level, then the device control module 128 sends the control signal CTR to the adapter control module 114, to decrease the charging current I_{CH} or the battery voltage V_{BAT} to its respective preset level.

In an embodiment, the control signal CTR is a current signal, a voltage signal, a PWM signal, or a PFM signal. The control signal CTR can be determined by the battery voltage V_{BAT}, the charging current I_{CH} of the battery 126, the system current, and the adapter output power. For example, the control signal CTR can be a PWM signal. If the charging current I_{CH} exceeds the preset charging current level, then the device control module 128 decreases the duty cycle of the control signal CTR sent to the adapter control module 114, to decrease the charging current I_{CH} and regulate the output power or output voltage of the adapter 110 to a target value. In another embodiment, the device control module 128 increases the duty cycle of the control signal CTR to decrease the charging current I_{CH} and regulate the output power or output voltage of the adapter 110 to the target value.

Advantageously, the charging management method of the present invention can identify the adapter type and perform the corresponding control, to increase charging efficiency and ensure charging safety. Furthermore, by utilizing the selective bypass and hybrid control described above, a bypass path can be formed for the larger current charging stage of the battery to improve efficiency and reduce power consumption and heat.

While the foregoing description and drawings represent embodiments of the present invention, it will be understood that various additions, modifications, and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A charging management method, comprising:
identifying a type of adapter that is connected to a device comprising a battery, wherein the type of adapter is one of at least a first type adapter and a second type adapter;
if the first type adapter is connected, setting a bypass/LDO (low dropout regulator) module to a first control mode comprising one of a bypass mode and a hybrid control mode; and
if the second type adapter is connected, setting the bypass/LDO module to a second control mode comprising the hybrid control mode,
wherein the bypass/LDO module comprises a first transistor and a second transistor;
wherein for the first control mode, a first enable signal and a second enable signal respectively control the first transistor and the second transistor so that, during a larger current charging stage of the battery, the first transistor and the second transistor both function as switches and a bypass path is formed, and so that, during a smaller current charging stage of the battery, the first transistor functions as a switch and the second transistor functions as an LDO and a hybrid path is formed; and
wherein for the second control mode, the first enable signal and the second enable signal respectively control the first transistor and the second transistor so that the first transistor functions as a switch and the second transistor functions as an LDO and the hybrid path is formed.

2. The charging management method according to claim 1, wherein said identifying comprises identifying the type of adapter by detecting an output voltage default value of the adapter before charging.

3. The charging management method according to claim 1, wherein said identifying comprises identifying the type of adapter by changing a control signal sent to the adapter and monitoring whether an output voltage of the adapter changes with the control signal.

4. The charging management method according to claim 1, wherein said identifying comprises identifying the type of adapter by detecting whether a control signal with an adapter type indicator is received from the adapter.

5. The charging management method according to claim 1, further comprising replacing the hybrid path with a switch charging module of the device according to a priority setting.

6. The charging management method according to claim 5, wherein with the first type adapter connected to the device, the bypass path is used to deliver power during the larger current charging stage and the switch charging module is used to deliver power during the smaller current charging stage.

7. The charging management method according to claim 5, wherein with the second type adapter connected to the device, the switch charging module is used to deliver power during the larger current charging stage and during the smaller current charging stage.

8. The charging management method according to claim 1, wherein the larger current charging stage and the smaller current charging stage are determined by detecting a charging current and a battery voltage of the battery.

9. The charging management method according to claim 8, wherein the charging current is determined by monitoring a current flowing through a transistor coupled to the battery and performing a trimming calculation on the monitored current.

10. The charging management method according to claim 1, further comprising:
obtaining a feedback signal indicative of a charging parameter of the battery; and
based on the feedback signal, transmitting a corresponding control signal to the adapter to regulate an output of the adapter to a target value, wherein the output is selected from the group consisting of: output power and output voltage.

11. The charging management method according to claim 10, wherein the charging parameter comprises a charging current and a battery voltage of the battery and the control signal is a pulse-width modulation signal, and wherein if the charging parameter exceeds a corresponding preset level, a duty cycle of the control signal is decreased to decrease the charging current and to regulate the output of the adapter to the target value.

12. A device, comprising:
a bypass/LDO (low dropout regulator) module comprising a first transistor and a second transistor; and
a device control module configured to identify a type of an adapter that is connected to the device, wherein the type of adapter is one of at least a first type adapter and a second type adapter, and is also configured to transmit a first control signal to the bypass/LDO module according to the type of adapter, wherein the bypass/LDO module is configured to set a control mode according to the first control signal, wherein the control mode is one of a first control mode and a second control mode;
wherein if the first type adapter is connected to the device, then the bypass/LDO module is set to the first control mode comprising one of a bypass control mode and a hybrid control mode; and wherein if the second type adapter is connected to the device, then the bypass/LDO module is set to the second control mode comprising the hybrid control mode;
wherein for the first control mode, the first control signal controls the first transistor and the second transistor so that, during a larger current charging stage of a battery of the device, the first transistor and the second transistor both function as switches and a bypass path is formed and so that, during a smaller current charging stage of the battery, the first transistor functions as a switch and the second transistor functions as an LDO and a hybrid path is formed; and
wherein for the second control mode, the first control signal controls the first transistor and the second transistor so that the first transistor functions as a switch and the second transistor functions as an LDO and the hybrid path is formed.

13. The device according to claim 12, wherein the device control module is further configured to identify the type of adapter by detecting an output voltage default value of the adapter before charging.

14. The device according to claim 12, wherein the device control module is further configured to transmit a second control signal to the adapter and to identify the type of adapter by changing the second control signal sent to the adapter and monitoring whether an output voltage of the adapter changes with the second control signal.

15. The device according to claim 14, wherein the device control module further comprises an integrated circuitry bus that is configured to adjust the second control signal of the device control module according to a host command from a host device.

16. The device according to claim 12, wherein the device control module is further configured to identify the type of adapter by detecting whether a signal with an adapter type indicator is received from the adapter.

17. The device according to claim 12, further comprising a switch charging module, wherein the device control module is further configured to replace the hybrid path of the bypass/LDO module with the switch charging module according to a priority setting.

18. The device according to claim 17, wherein with the first type adapter connected to the device, the device control module is further configured to use the bypass path of the bypass/LDO module to deliver power during the larger current charging stage and to use the switch charging module to deliver power during the smaller current charging stage.

19. The device according to claim 17, wherein with the second type adapter connected to the device, the device control module is further configured to use the switch charging module to deliver power during the larger current charging stage and during the smaller current charging stage.

20. The device according to claim 12, wherein the device control module comprises:
a monitor unit;
an adapter control unit coupled to the monitor unit and configured to identify whether the first type adapter or the second type adapter is connected to the device and to transmit a second control signal to the adapter according to an output of the adapter;
a central control unit coupled to the adapter control unit and configured to receive a type indicator signal indicative of the type of adapter from the adapter control unit, to receive a battery status signal indicative of a charging current and a battery voltage from the monitor unit, and to determine whether the battery is in a current charging stage comprising one of the larger current charging stage and the smaller current charging stage; and
a charge control unit coupled to the central control unit and configured to selectively enable the bypass/LDO module according to the type of adapter and the current charging stage.

21. The device according to claim 20, wherein the monitor unit is further configured to monitor a current flowing through a transistor coupled to the battery and perform a trimming calculation on the monitored current to obtain the charging current.

22. The device according to claim 12, wherein the bypass/LDO module is further configured to be used as a charge pump to perform a boost operation.

23. The device according to claim 12, wherein the device control module is further configured to:
obtain a feedback signal indicative of a charging parameter; and
based on the feedback signal, transmit a second control signal to the adapter to regulate an output of the adapter to a target value, wherein the output is selected from the group consisting of: output power and output voltage.

24. The device according to claim 23, wherein the charging parameter comprises a charging current and a battery voltage of the battery, the second control signal is a pulse-width modulation signal, and wherein if the charging parameter exceeds a corresponding preset value, then the device control module is further configured to decrease a duty cycle of the second control signal to decrease the charging current and regulate the output of the adapter to the target value.
